(19) United States
(12) Patent Application Publication
(10) Pub. No.: US 2009/0226652 A1
(43) Pub. Date: Sep. 10, 2009

(54) Framework for assembly around a gift, surprise or present

(76) Inventors: Peter Jones, Manchester (GB); Philip Dale, Manchester (GB)

Correspondence Address: Peter Jones, 21 Whinberry Way, Moorside, Oldham, Manchester, OL4 2NN, GB

(21) Appl. No.: 12/152,164

(22) Filed: May 14, 2008

(30) Foreign Application Priority Data
Mar. 10, 2008 (GB) GB0804580.9

(51) Int. Cl. B32B 1/08

(52) U.S. Cl. 428/35.7

(57) ABSTRACT

This invention is designed to provide a solution to a problem that exists when considering how to present a gift predominantly to a child. This is a plastic modular frame that is easily erected and fits over an assembled, tested and/or unusual shaped gift. By creating the cubic frame, it becomes easy to attach standard gift wrapping paper to the frame and conceal the gift inside. Rods and connecting spigots have a unique triangular profile and being produced in plastic are reusable to the consumer. Attached drawings show an assembled frame (FIG. 9) together with drawings of each of the main components; corner piece, adaptor and rod profile (FIGS. 1 to 8). See paragraph 0010 for full description of each drawing.

This invention is designed specifically to solve a problem that exists when preparing certain gifts or presents, predominantly but not exclusively for children.

| | |
|---|---|
| Name of first Inventor: | Peter Jones |
| Inventors' residence: | 21 Whinberry Way |
| | Moorside |
| | Oldham |
| | Greater Manchester |
| Post code/Zip code | OL4 2NN |
| Country of residence: | United Kingdom |
| Telephone: | +44 161 678 9765 |
| e-mail: | peter.jones@buildnwrap.com |
| Name of second Inventor: | Philip Dale |
| Inventors' residence: | 9 Watermill Clough |
| | Royton |
| | Oldham |
| | Greater Manchester |
| Post code/Zip code | OL2 5WB |
| Country of residence: | United Kingdom |
| Telephone: | +44 161 628 0164 |
| e-mail: | phil.dale@buildnwrap.com |

### REFERENCE TO RELATED APPLICATIONS

A patent application has been made though the United Kingdom patent office. This is filed under application number GB0804580.9 with a filing date of 10 Mar. 2008. No priority is being claimed from the UK application.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Many gifts such as dolls houses or toy garages require assembly after purchase. This creates a dilemma as the parent/guardian may opt to leave the gift unassembled and in the packaging in which it was bought. However this means that once opened on the day of the celebration, the toy will require assembly before the child can play with it. Further problems may be created if for instance, there are parts missing or not functioning correctly. An alternative to this would be to assemble the toy in advance of the day of the celebration. This does allow the bearer of the gift the opportunity to check the functionality of the toy and of course will allow The child to play with it immediately. However, when doing this the toy is unlikely to fit in its original packaging. It may also be an unusual shape that makes it difficult to wrap. This invention is a plastic frame that is easily assembled and can fit over the parameters of the gift. The frame produces a basic cube that allows the user to attach traditional gift wrapping paper to it. The gift is then assembled, tested and can be concealed in readiness for the recipient of the gift.

Other gifts exist that may not require lengthy assembly but are an unusual shape such as bicycles, rocking horses, ride on toys etc. would also benefit from such a system. A bicycle for instance is difficult to wrap due to its complex shape. The framework can be assembled so as to create a cube that is larger than the bicycle. As a cube, it is then easy to attach gift wrapping paper to the frame and conceal the identity of the gift.

### BRIEF SUMMARY OF THE INVENTION

The primary objective of this invention is to provide a system of rods and connectors that allow the user to easily and quickly construct a cubic frame that will fit over a gift or present. There are four main components that are used to create the framework. A 3-dimensional corner fitting (FIGS. 1-3) that has three triangular spigots (or legs) protruding from a cube in the x, y and z axis. The second piece is an adaptor fitting (FIGS. 4-6) that is triangular shaped and has two spigots along the same axis. There are two extruded rods of different lengths and both triangular in shape (FIGS. 7 & 8). These are suitably sized to fit over the spigots on the corner piece and adaptor. The two different lengths allow the user optional lengths dependent on the size of the gift. Where one rod is length ‘x’ and the second rod length ‘y’, the frame can have a width, height or depth of lengths ‘x’, ‘y’ or ‘x+y’. ‘x+y’ is achieved using the adaptor (FIGS. 4-6) to connect the two lengths. The materials used for this invention are a combination of polypropylene and pvc and are therefore re-usable to the consumer.

### BRIEF DESCRIPTION OF THE DRAWINGS

Attached drawings:

FIG. 1: Front view of the corner piece

FIG. 2: Plan view of the corner piece

FIG. 3: 3-dimensional perspective view of the corner piece

FIG. 4: Front view of the adaptor

FIG. 5: Plan view of the adaptor

FIG. 6: 3-dimensional perspective view of the adaptor piece

FIG. 7: Plan view of the rod profile

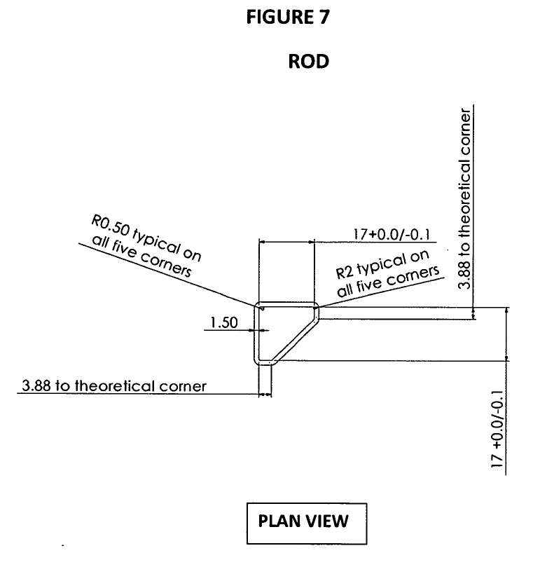

FIG. 8: 3-dimensional perspective view of the rod profile

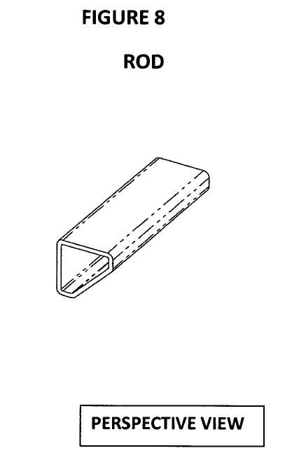

FIG. 9: 3-dimensional perspective view of the assembled frame

### DETAILED DESCRIPTION OF THE INVENTION

Both corner piece and adaptor have ribs (or a raised profile of lines) that helps create a firm fit when the rods are engaged on to the spigot. A triangular profile has been selected as this offers benefits over a rectangular or square profile. Firstly, less plastic is used and secondly when packaging the product two rods can be placed together with the hypotenuse faces together to reduce its packaged size.

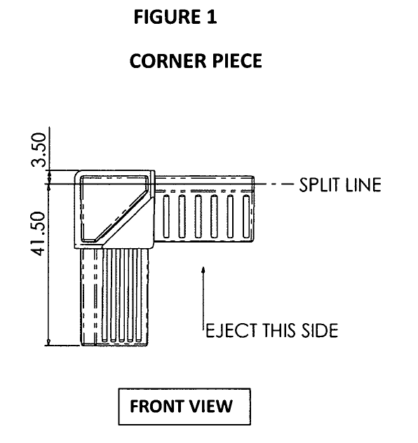

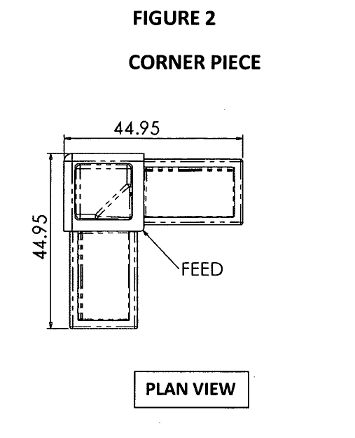

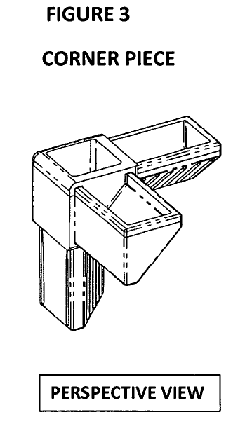

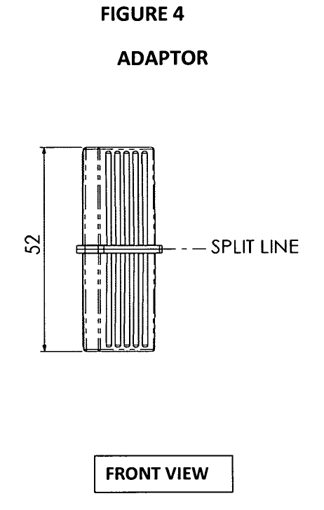

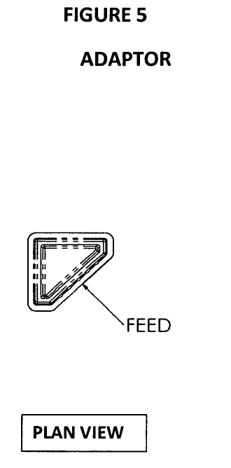

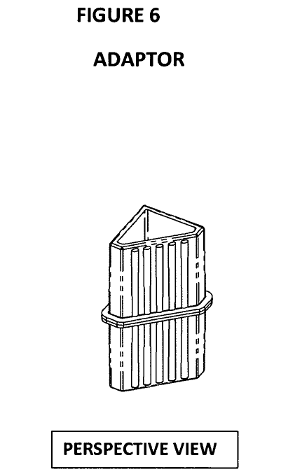

The corner piece (FIGS. 1-3) and adaptor (FIGS. 4-6) are designed specifically for production through injection moulding and with appropriate cavities to ease the production process and reduce weight and material content.

The two rods have a specific tolerance so as to ensure a firm fit over the spigots and are of a rigid PVC material to achieve the required straightness over their length. They are to be manufactured as conventional Extrusions.

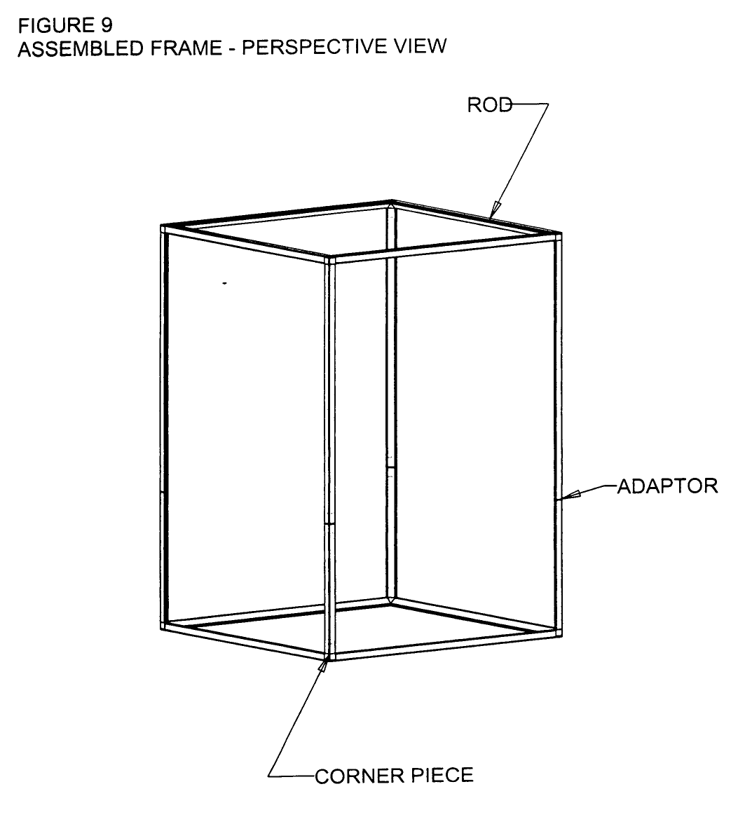

The packaged product will consist of eight corner fittings and twelve adaptors, suitable to create a 3 dimensional frame. The number of rods will determine the parameters of the assembled framework. A typical assembled frame is shown on FIG. 9.

1. A modular plastic frame specifically for the purpose of concealing gifts

2. The frame in claim 1 being cubic in its assembled form and therefore providing ease of attaching gift wrapping paper

3. The frame in claim 1 having a variety of rod lengths that allows flexibility in its assembled size.

4. Flexibility in claim 3 being such that make it suitable for a large number of gifts, toys etc

5. Plurality of connections having a triangular shaped profile

6. Corner fittings having three spigots at 90 degrees across three axis

7. Each spigot referred to in claim 6 to have a series of parallel raised ribs.

8. The above ribs to create a push-on fit for the connecting rods

9. All rods to be interchangeable with each spigot and adaptor

10. Adaptors to have a sequence of ribs as that referred to in claim 7.

11. All components to be manufactured from polypropylene and rigid PVC

12. Material referred to in claim 11 make the frame re-usable.
